(19) United States
(12) Patent Application Publication
(10) Pub. No.: US 2008/0248334 A1
(43) Pub. Date: Oct. 9, 2008

(54) MOLD STRUCTURE, IMPRINTING METHOD USING THE SAME, MAGNETIC RECORDING MEDIUM AND PRODUCTION METHOD THEREOF

(75) Inventors: Kenichi Moriwaki, Kanagawa (JP); Masakazu Nishikawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,987

(22) Filed: Mar. 31, 2008

(30) Foreign Application Priority Data
Mar. 30, 2007 (JP) 2007-094899
Jan. 25, 2008 (JP) 2008-015166

(51) Int. Cl. G11B 5/66

(52) U.S. Cl. 428/817; 264/293; 249/114.1; 264/219

(57) ABSTRACT

To provide a mold structure which is excellent in the transfer quality of a pattern to a substrate and superior in its separability from an imprint resist layer and which allows a high-quality pattern to be transferred and formed on discrete track media and patterned media. Specifically, there is a mold structure including: convex portions and concave portions formed on its surface, wherein the mold structure is used for transferring a concavo-convex pattern onto an imprint resist layer formed on a surface of a substrate having a thickness of 0.3 mm to 2.0 mm by pressing the convex portions and the concave portions against the imprint resist layer, and wherein a ten-point average roughness Rz₁ of apical portions of the convex portions and a ten-point average roughness Rz₂ of bottom portions of the concave portions are in the range of 0.5 nm to 20 nm each.

### BACKGROUND OF THE INVENTION

1. Field of the Invention

The present invention relates to a mold structure provided with a concavo-convex pattern used for transferring information onto a magnetic recording medium, an imprinting method using the same, a magnetic recording medium and a method for producing the magnetic recording medium.

2. Description of the Related Art

In recent years, hard disk drives that are superior in high-speed reading and writing process and low in costs have begun being incorporated in portable devices such as cellular phones, compact acoustic devices and video cameras as major storage devices, and a technique for increasing recording density has been required to meet the demand for further sizing down and increasing capacity.

In order to increase the recording density of hard disk drives, a method of improving the performance of magnetic recording media and a method of narrowing the magnetic head width have been conventionally used; however, as spaces between data tracks are made narrow, effects of magnetism between adjacent tracks (crosstalk) and effects of heat fluctuation become noticeable, so that there is a limitation on improvement in recording density by means of the narrowing of magnetic heads or the like.

Accordingly, magnetic recording media in a form referred to as discrete track media have been proposed as a solution to noise caused by crosstalk (refer to Japanese Patent Application Laid-Open (JP-A) Nos. 56-119934 and O₂-201730).

In discrete track media, magnetic interference between adjacent tracks is decreased by means of discrete structures in which nonmagnetic guard band regions are provided between adjacent tracks so as to magnetically separate tracks from one another.

Also, magnetic recording media in a form referred to as bit patterned media, in which bits for recording signals are provided in predetermined patterns of shape have been proposed as a solution to demagnetization caused by heat fluctuation (refer to JP-A No. 03-22211).

As a method for producing the discrete track media and the bit patterned media, there is an imprinting method in which a desired pattern is transferred onto a resist layer formed on a surface of a magnetic recording medium by using a resist pattern forming mold (otherwise referred to as “stamper”), as disclosed in JP-A No. 2004-221465.

Incidentally, when a mold is used for transferring a pattern onto a magnetic recording medium, it is necessary to carry out nanoimprint lithography (NIL) finely and for a large area, and thus uniformity and stability of NIL are important. In addition, it is necessary to mainly create two types of patterns, i.e. a servo signal used for positioning a magnetic head and a data signal used in reading/recording actual data. A data portion is formed of a simple pattern, for example a concentric pattern in the case of a discrete track medium (DTM) or a dotted pattern in the case of a bit patterned medium (BPM). A servo portion is mainly formed of four patterns exemplified by a preamble, a servo timing mark, an address (sector and cylinder) and a burst. In the address (sector and cylinder) and burst pattern portions, patterns are present in a mixed manner, thereby creating complex pattern arrangements.

Since a complex pattern is densely formed on an entire surface of a disk as described above, accurate transfer of a concavo-convex pattern of a mold structure to an entire surface of an imprint resist layer is required during NIL.

In this imprinting method, since a large number of transfer processes are required in view of cost reduction, it is necessary for the mold structure to withstand at least several hundreds to several tens of thousands of times of transfer.

Accordingly, in order to improve durability in transfer, a technique in which a rigid body such as a silicon substrate is used in a mold structure has been disclosed (refer to U.S. Pat. No. 5,772,905 and Appl. Phys. Lett., vol. 67, 3314, 1995 by S. Y. Chou, et al.). According to the patent literature, very high pattern accuracy can be obtained, and it is possible to realize transfer of minute patterns including those of submicron size or of the order of several tens of nanometers.

Here, in the case where concave portions and convex portions constituting the concavo-convex pattern of the mold structure include local protrusions and depressions, the thickness of a resist pattern to be formed and the presence of a residual film become nonuniform throughout an entire surface.

When an entire surface is unevenly shaped as described above, nonuniformity (of thickness and width) is caused during patterning of a magnetic layer of a magnetic recording medium in a process (e.g. etching process) subsequent to an imprinting process, and so output of data from the magnetic layer of the magnetic recording medium is not uniform. In this case, as amplitude of reproduction, modulation is reduced. Further, there is a defect in which a reduction in SNR (signal-to-noise ratio) is caused.

To solve these problems, reducing the surface roughness of the concave portions and the convex portions constituting the concavo-convex pattern is effective and makes it possible to yield uniformity in the thickness of a resist pattern and of the presence of a residual film.

The problems can be solved by enhancing adhesion by the formation of a smooth surface; however, great force is required to separate the surface, which may cause damage to the mold structure or cause the imprint resist layer itself to separate, and thus there is a problem in which the durability of the mold structure is lessened (refer to JP-A No. 2004-288845).

Additionally, a technique designed to reduce the average surface roughness of the convex portions of the concavo-convex pattern is disclosed in JP-A No. 2006-85795 so as to solve such problems; however, the object to be imprinted with a pattern is a substrate, so that there is no mention of an etching process subsequent to a patterning process and there is no disclosure or suggestion about a means for solving the problems at the time of separation.

Therefore, as things stand at present, a mold structure which is excellent in the transfer quality of a pattern to a substrate and superior in its separability from an imprint resist layer and which allows a high-quality pattern to be transferred and formed on discrete track media and patterned media, and related techniques have not yet been realized, and provision thereof is hoped for.

### BRIEF SUMMARY OF THE INVENTION

The present invention is aimed at solving the problems in related art and achieving the following object. Specifically, an object of the present invention is to provide a mold structure which is excellent in the transfer quality of a pattern to a substrate and superior in its separability from an imprint resist layer and which allows a high-quality pattern to be transferred and formed on discrete track media and patterned media; an imprinting method using the same; a magnetic recording medium; and a method for producing the magnetic recording medium.

As a result of carrying out earnest examinations, the present inventors have found that the problems can be solved by setting both a ten-point average roughness Rz₁ of apical portions of convex portions and a ten-point average roughness Rz₂ of bottom portions of concave portions in a predetermined range.

The present invention is based upon the aforementioned knowledge of the present inventors, and the following are means for solving the aforementioned problems.

<1> A mold structure including: convex portions and concave portions formed on its surface, wherein the mold structure is used for transferring a concavo-convex pattern onto an imprint resist layer formed on a surface of a substrate having a thickness of 0.3 mm to 2.0 mm by pressing the convex portions and the concave portions against the imprint resist layer, and wherein a ten-point average roughness Rz₁ of apical portions of the convex portions of the mold structure and a ten-point average roughness Rz₂ of bottom portions of the concave portions of the mold structure are in the range of 0.5 nm to 20 nm each.

As to the mold structure according to <1>, since both the ten-point average roughness Rz₁ of the apical portions and the ten-point average roughness Rz₂ of the bottom portions are in the range of 0.5 nm to 20 nm, it is possible to provide a mold structure which is superior in the adhesion of a residual layer to the substrate and separability from the imprint resist layer formed on the surface of the substrate and which allows a high-quality pattern to be transferred and formed on discrete track media and patterned media.

<2> The mold structure according to <1>, wherein the ten-point average roughness Rz₁ of the apical portions is in the range of 0.5 nm to 10 nm.

<3> The mold structure according to any one of <1> and <2>, wherein an average surface roughness Ra₁ of the apical portions, an average surface roughness Ra₂ of the bottom portions and an average surface roughness Ra₃ of sidewall portions are in the range of 0.1 nm to 5 nm each.

<4> The mold structure according to any one of <1> to <3>, wherein the average surface roughness Ra₁ of the apical portions and an average surface roughness Raₛ of the surface of the substrate covered with the imprint resist layer satisfy Relationship (1) below.

Ra₁≧Raₛ Relationship (1)

<5> The mold structure according to any one of <1> to <4>, having a thickness of 0.5 mm to 10 mm.

<6> The mold structure according to any one of <1> to <5>, wherein the mold structure is formed of a material selected from quartz, metal and resin.

<7> An imprinting method including: transferring a concavo-convex pattern onto an imprint resist layer on a surface of a substrate by pressing convex portions and concave portions on a surface of a mold structure against the imprint resist layer, wherein a ten-point average roughness Rz₁ of apical portions of the convex portions and a ten-point average roughness Rz₂ of bottom portions of the concave portions are in the range of 0.5 nm to 20 nm each.

<8> A method for producing a magnetic recording medium, including: producing a magnetic recording medium with the use of the imprinting method according to <7>.

<9> A method for producing a magnetic recording medium, including: transferring a concavo-convex pattern formed on a mold structure onto an imprint resist layer formed on a substrate of the magnetic recording medium by pressing the mold structure against the imprint resist layer; forming a magnetic pattern portion, which corresponds with the concavo-convex pattern, on a magnetic layer on a surface of the substrate of the magnetic recording medium by etching the magnetic layer, using the imprint resist layer onto which the concavo-convex pattern has been transferred as a mask; and forming a nonmagnetic pattern portion by filling concave portions in the magnetic layer with a nonmagnetic material, wherein the mold structure is the mold structure according to any one of <1> to <6>.

<10> The method for producing a magnetic recording medium according to any one of <8> and <9>, wherein the magnetic recording medium is one of a discrete magnetic recording medium and a patterned magnetic recording medium.

<11> A magnetic recording medium produced by the method for producing a magnetic recording medium according to any one of <8> to <10>.

<12> The magnetic recording medium according to <11>, which is one of a discrete magnetic recording medium and a patterned magnetic recording medium.

According to the present invention, it is possible to solve problems in related art and provide a mold structure which is excellent in the transfer quality of a pattern to a substrate and superior in its separability from an imprint resist layer and which allows a high-quality pattern to be transferred and formed on discrete track media and patterned media; an imprinting method using the same; a magnetic recording medium; and a method for producing the magnetic recording medium.

### BRIEF DESCRIPTION OF THE SEVERAL VIEWS OF THE DRAWINGS

FIG. 1 is a partial perspective view showing the constitution of one embodiment of a mold structure according to the present invention.

FIG. 2A is a process drawing showing one example of a method for producing a mold structure in Examples 1 to 11.

FIG. 2B is another process drawing showing the example of a method for producing the mold structure in Examples 1 to 11.

FIG. 3 is a process drawing showing a method for producing a magnetic recording medium by using a mold structure according to the present invention.

FIG. 4A is a process drawing showing one example of a method for producing a mold structure in Example 12.

FIG. 4B is another process drawing showing the example of a method for producing the mold structure in Example 12.

FIG. 5A is a process drawing showing one example of a method for producing a mold structure in Example 13.

FIG. 5B is another process drawing showing the example of a method for producing the mold structure in Example 13.

### DETAILED DESCRIPTION OF THE INVENTION

The following explains mold structures of the present invention with reference to the drawings.

### <Constitution of Mold Structure>

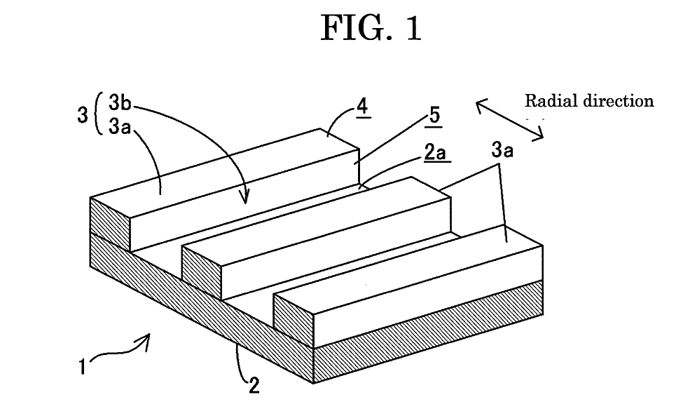

FIG. 1 is a partial perspective view showing the constitution of one embodiment of a mold structure according to the present invention.

As shown in FIG. 1, a mold structure 1 of the present embodiment has a plurality of convex portions 3a formed in the shape of concentric circles at predetermined intervals on one surface 2a (hereinafter otherwise referred to as “reference surface 2a”) of a disk-shaped substrate 2.

The convex portions are provided correspondingly to a servo portion and a data portion of a magnetic recording medium.

The data portion is formed of a pattern of convexities substantially in the shape of concentric circles and records data.

The servo portion is formed of a plurality of different patterns of convexities with different areas.

The servo portion corresponds to a tracking servo control signal and is mainly composed, for example, of a preamble pattern, a servo timing mark, an address mark, a burst pattern or the like.

The preamble pattern generates a reference clock signal for reading control signals from an address pattern region, etc.

The servo timing mark serves as a trigger signal for reading the address mark and the burst pattern.

The address pattern includes sector (angle) information and track (radius) information and presents the absolute position (address) of a disk.

The burst pattern has the function of finely adjusting the magnetic head's position and thus enabling highly accurate positioning, when the magnetic head is in a on-track state.

The material for the substrate 2 of the mold structure is not particularly limited and can be suitably selected according to the purpose, with any one of quartz, metal and resin being preferable.

Examples of the metal include Ni, Cu, Al, Mo, Co, Cr, Ta, Pd, Pt, Au and alloys thereof. Among these, Ni and alloys of Ni are particularly preferable.

Examples of the resin include polyethylene terephthalate (PET), polyethylene naphthalate (PEN), polycarbonate (PC), polymethyl methacrylate (PMMA), cellulose triacetate (TAC) and low glass transition temperature fluorine resins.

Note that in the present embodiment, the convex portions 3a and concave portions 3b formed between the convex portions 3a are collectively referred to as “concavo-convex portions 3”.

The convex portions 3a include apical portions 4 that are substantially parallel to the reference surface 2a, and sidewall portions 5 that connect bottom portions (the reference surface 2a) with the apical portions 4.

The cross-sectional shape of each of the convex portions 3a with respect to the radial direction of the concentric circles (the direction in which the convex portions 3a are disposed one after another) is a rectangle, for example.

It should be noted that the cross-sectional shape of each of the convex portions 3a is not limited to rectangle, and any shape can be selected according to the purpose by controlling the after-mentioned etching step.

Hereinafter, in explanations of the present embodiment, the term “cross-section(al shape)” denotes a cross-section(al shape) with respect to the radial direction of the concentric circles (the direction in which the convex portions 3a are disposed one after another) unless otherwise stated.

The ten-point average roughness Rz₁ of the apical portions 4 of the convex portions 3a constituting the concavo-convex pattern (concavo-convex portions 3) formed on the surface of the mold structure 1 of the present invention and the ten-point average roughness Rz₂ of the bottom portions (reference surface 2a) of the convex portions 3a are preferably in the range of 0.5 nm to 20 nm each. Ideally, the ten-point average roughness Rz₁ of the apical portions 4 is in the range of 0.5 nm to 10 nm. Here, it is technically possible to obtain a mold structure suitable for the present invention even if Rz is 0.5 nm or less. However, in order to obtain such excessively smooth surface quality, it is necessary to improve the present-day processing technique to an extreme degree, which is not realistic both technically and in terms of costs. For this reason, the reduction in Rz is not suitable for the aim of the present invention and is therefore excluded.

The thickness of the substrate whose surface is covered with an imprint resist layer which is imprinted with the concavo-convex pattern by pressing the concavo-convex portions 3 against the imprint resist layer is preferably 0.3 mm to 2.0 mm. In the case where the thickness of the substrate is less than 0.3 mm, the rigidity of the substrate itself becomes low, and the flying stability of the magnetic head comes to be unstable because of surface shaking caused when the substrate is rotated at high speed. When the thickness of the substrate is greater than 2.0 mm, the substrate becomes heavier, so that not only can it be suitably applied to fewer products, but also there is an increase in material costs.

Also, the average surface roughness Ra₁ of the apical portions 4 of the convex portions 3a constituting the concavo-convex pattern (concavo-convex portions 3) formed on the surface of the mold structure 1 of the present invention, the average surface roughness Ra₂ of the bottom portions (reference surface 2a) of the convex portions 3a and the average surface roughness Ra₃ of the sidewall portions 5 of the convex portions 3a are preferably in the range of 0.1 nm to 5 nm each.

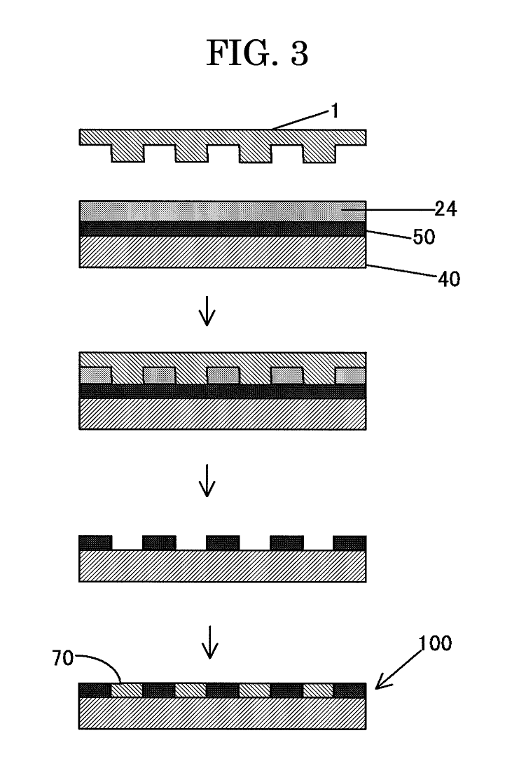

Further, the aforementioned average surface roughness Ra₁ and the average surface roughness Raₛ of the surface of a substrate 40 (see FIG. 3) on the side where an imprint resist layer is formed satisfy Relationship (1) below.

Ra₁≧Raₛ Relationship (1)

Here, regarding the ten-point average roughnesses Rz₁ and Rz₂, the surface roughness of rectangular regions, each of which has a side that is at least ten times greater than a minimum pattern size, was measured and evaluated using an AFM (atomic force microscope). Then the five highest points are selected from measurement locations in the region of the convex portions (apical portions) and the five lowest points are selected from measurement locations in the region of the concave portions (bottom portions), and the sum of the average heights thereof is calculated as Rz. On this occasion, it is possible to evaluate only central portions of the regions by excluding areas that are within 10 nm of boundaries between the convex portions and the concave portions.

As for the average surface roughnesses Ra₁, Ra₂ and Ra₃, the surface roughness is measured and evaluated using an AFM as described above. Measurement locations in the regions of the convex portions, the concave portions and the sidewall portions are measured for the absolute values of deviations from average lines, and the absolute values are added together and then averaged as Ra. On this occasion, it is possible to carry out the evaluation with greater reproducibility by measuring only central portions of the regions as described above.

Also, it is desirable that the thickness of the substrate 2 be in the range of 0.5 mm to 10 mm.

### (Method for Producing Mold Structure)

The following explains a method for producing a mold structure according to the present invention, with reference to the drawings.

### FIRST EMBODIMENT

### <<Production of Master Plate>>

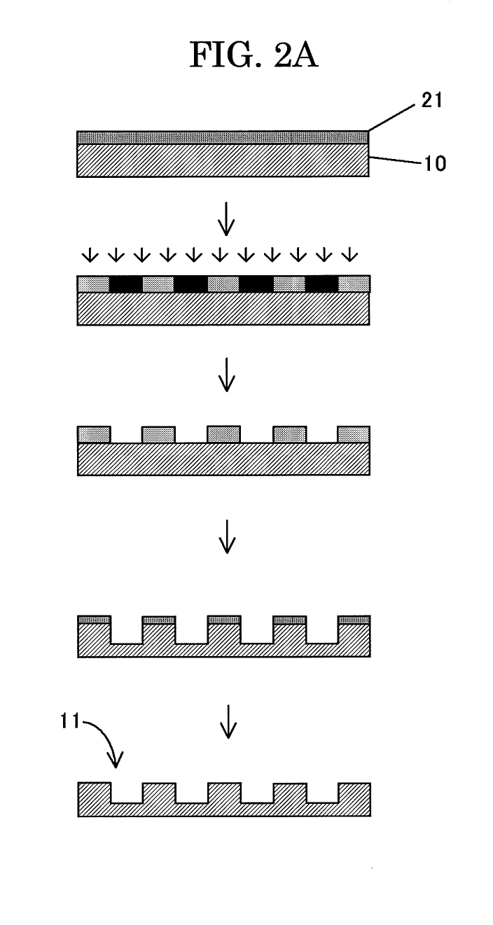

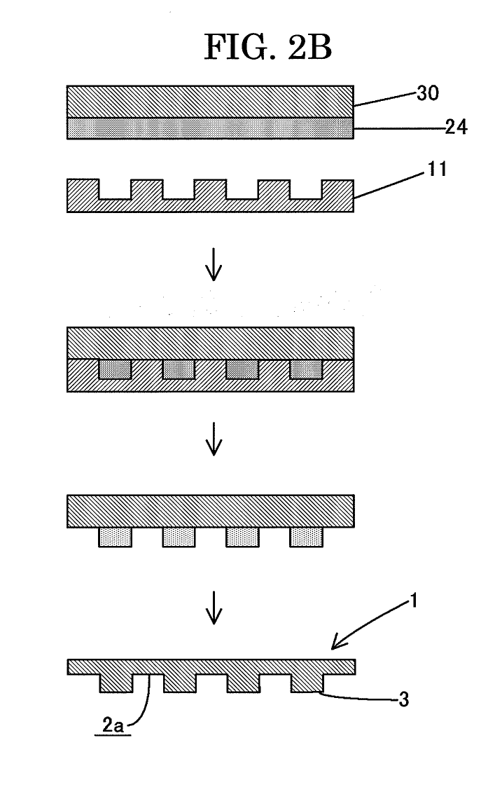

FIGS. 2A and 2B are cross-sectional views showing a method for producing a mold structure according to a first embodiment. First of all, as shown in FIG. 2A, a photoresist solution of PMMA, etc. is applied onto a Si substrate 10 by spin coating or the like to form a photoresist layer 21.

After that, while the Si substrate 10 is being rotated, a laser beam (or an electron beam) modulated correspondingly to a data recording track and a servo signal is applied onto the Si substrate 10, and the entire photoresist surface is exposed with predetermined patterns, for example a data track pattern formed of a pattern of convexities substantially in the shape of concentric circles, a servo pattern formed of a plurality of different patterns of convexities with different areas, and a buffer pattern formed of a pattern of convexities which are radially arranged and continuous in the radial direction between the data track pattern and the servo pattern.

Subsequently, the photoresist layer 21 undergoes a developing process, exposed portions are removed, then selective etching is carried out by RIE (reactive ion etching) or the like as the pattern of the photoresist layer 21 after the removal serves as a mask, and a concavo-convex pattern is thus formed on the substrate 10.

Next, the residual resist layer 21 is removed to yield a master plate 11 having a concavo-convex shape.

### <<Production of Mold Structure>>

Next, as shown in FIG. 2B, the master plate 11 is pressed against a quartz substrate 30 that is a substrate to be processed, whose one surface is covered with an imprint resist layer 24 made by applying an imprint resist solution containing a photocurable resin or the like, and the patterns of the convex portions formed on the master plate 11 are thus transferred onto the imprint resist layer 24.

### <<Imprint Resist Layer>>

The imprint resist layer is, for example, an imprint resist composition (hereinafter otherwise referred to as “imprint resist solution”) containing at least one of thermoplastic resin, thermosetting resin and photocurable resin, and it is applied onto a substrate, a magnetic recording medium or the like.

The thickness of the imprint resist layer can, for example, be optically measured using an ellipsometer, etc. or measured by means of contact measurement using a stylus profilometer, an atomic force microscope (AFM), etc.

For the imprint resist composition, a material having thermoplasticity, a material having photocurability, a sol/gel or the like can be used. Suitable examples thereof include resins that have those features and also high dry etching resistance, such as novolac resins, epoxy resins and alicyclic resins; and resins having excellent peelability, such as fluorine resins.

Here, the material for the substrate to be processed in the present invention is not particularly limited and can be suitably selected according to the purpose, as long as it transmits light and has the strength necessary for it to function as a mold structure. Examples thereof include quartz (SiO₂) and organic resins (PET, PEN, polycarbonate, low glass transition temperature fluorine resins and PMMA).

The specific meaning of the expression “transmits light” is that the imprint resist is sufficiently cured when light is applied in such a manner as to enter one surface of the substrate to be processed and exit the other surface thereof covered with the imprint resist layer, and that the light transmittance from the one surface to the other surface is 50% or greater.

The specific meaning of the expression “has the strength necessary for it to function as a mold structure” is such strength as enables the material to withstand the pressurization when the master plate is pressed against the imprint resist layer on the substrate of the magnetic recording medium at 4 kgf/cm² in average surface pressure.

### <<Curing Step>>

Thereafter, the transferred pattern is cured by irradiating the imprint resist layer 24 with an ultraviolet ray or the like.

### <<Pattern Forming Step>>

Subsequently, selective etching is carried out by RIE or the like, with the transferred pattern serving as a mask, to yield the mold structure 1 having a concavo-convex shape.

Note that the selective etching is carried out such that concave portions of the mold structure 1 having the concavo-convex shape correspond with the convex portions 3a in FIG. 1 in cross-sectional shape.

### <<Release Layer Forming Step>>

A release agent layer is formed on the concavo-convex surface of the mold structure produced. It is desirable that the release agent layer be formed on the surface of the mold structure so as to be able to peel off at the interface between the mold structure and the imprint resist layer after imprinting. The material for the release agent can be arbitrarily selected, provided that it easily adheres and bonds to the mold structure and hardly adsorbs onto the imprint resist layer surface. In particular, fluorine resin is preferable in that it hardly adsorbs onto the resist layer surface.

It is desirable that the release agent layer be made as thin as possible because when it is thick, there is a reduction in pattern accuracy. Specifically, the thickness thereof is desirably 10 nm or less, more desirably 5 nm or less.

As a means of forming the release agent layer, coating or vapor deposition can be employed. Additionally, after the release agent layer has been formed, it is possible to provide, for example, a step of enhancing the adsorbability of the release agent to the mold structure by baking or the like.

### SECOND EMBODIMENT

### <<Production of Master Plate>>

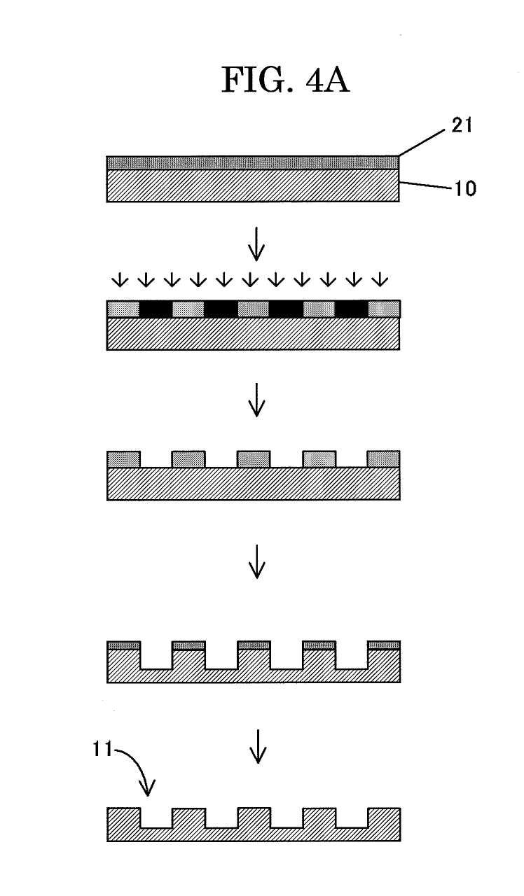

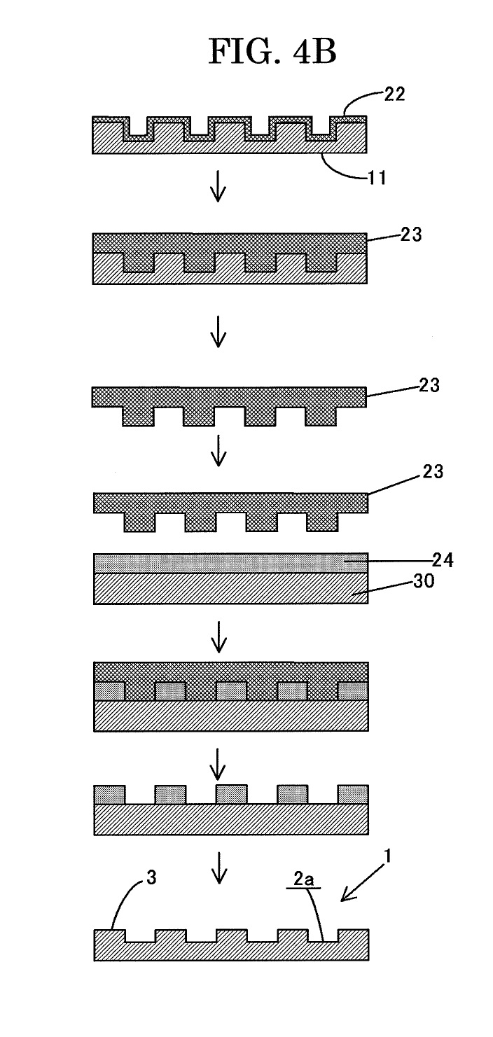

FIGS. 4A and 4B are process drawings showing a method for producing a mold structure according to a second embodiment. A master plate 11 having a concavo-convex pattern was produced as in the first embodiment.

### <<Production of Mold Structure>>

A Ni mold structure was produced by forming a conductive film on the surface of the master plate by sputtering, and immersing the master plate provided with the conductive film in a Ni electroforming bath to electroform the master plate.

A conductive film 22 can be formed on the concavo-convex pattern of the master plate 11 by processing a conductive material in accordance with a vacuum deposition method such as vacuum vapor deposition, sputtering or ion plating, a plating method, or the like. The conductive material can be suitably selected according to a subsequent step (electroforming), but it is preferably a Ni-based, Fe-based or Co-based metal/alloy material or the like. It is desirable that the thickness of the Ni mold structure obtained through the electroforming process be in the range of 20 μm to 800 μm, more desirably in the range of 40 μm to 400 μm.

### <<Release Layer Forming Step>>

It is desirable that a release agent layer be formed on the surface of the Ni mold structure as in the first embodiment.

### THIRD EMBODIMENT

### <<Production of Master Plate>>

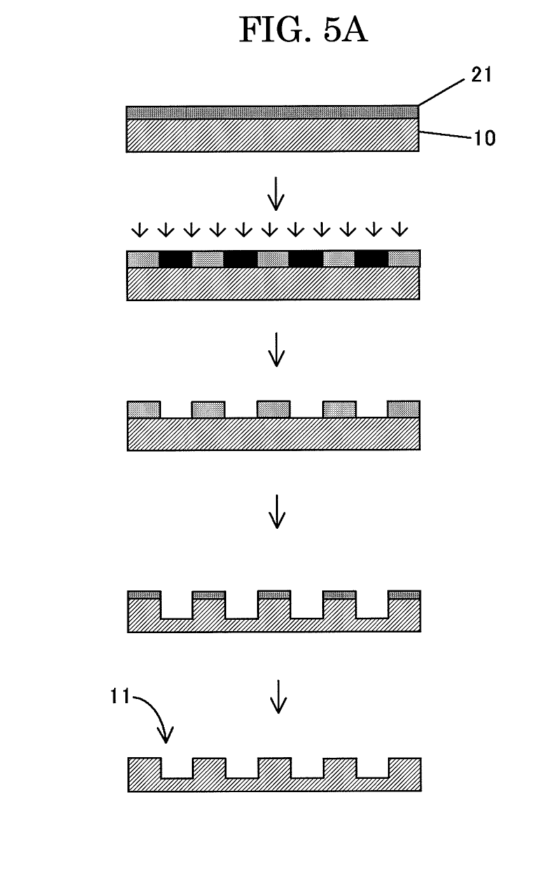

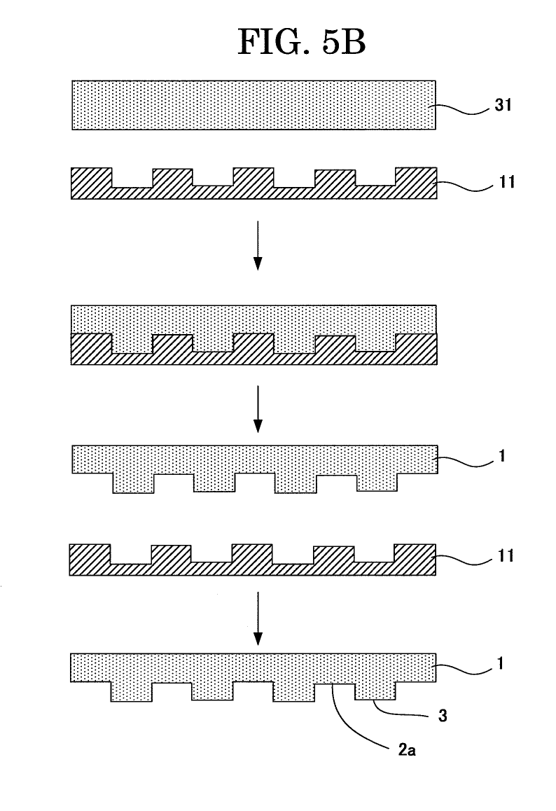

FIGS. 5A and 5B are process drawings showing a method for producing a mold structure according to a third embodiment. A master plate 11 having a concavo-convex pattern was produced as in the first embodiment.

### <<Production of Mold Structure>>

The master plate 11 was pressed against a thermoplastic resin sheet 31. After that, by heating the sheet to a temperature equal to or higher than the softening temperature of the resin, the viscosity of the resin decreased, and the pattern of convex portions formed on the master plate was transferred onto the resin sheet 31. Subsequently, the transferred pattern was cured by cooling, and the resin sheet was peeled away from the master plate 11 to yield a resin mold structure 1 having a concavo-convex shape.

Here, the resin material is not particularly limited and can be suitably selected according to the purpose, as long as it has thermoplasticity, transmits light and has the strength necessary for it to function as a mold structure. Examples thereof include PET, PEN, polycarbonate, low glass transition temperature fluorine resins and PMMA.

The specific meaning of the expression “transmits light” is that an imprint resist is sufficiently cured when light is applied in such a manner as to enter one surface of a substrate to be processed and exit the other surface thereof covered with an imprint resist layer, and that the light transmittance from the one surface to the other surface is 50% or greater.

The specific meaning of the expression “has the strength necessary for it to function as a mold structure” is such strength as enables the resin material to withstand the pressurization when the master plate is pressed against the imprint resist layer on a substrate of a magnetic recording medium at 4 kgf/cm² in average surface pressure.

### <<Release Layer Forming Step>>

It is desirable that a release agent layer be formed on the surface of the resin mold structure as in the first embodiment.

The mold structure of the present invention can be suitably used in an imprinting method including a transfer step in which the convex portions of the mold structure are placed facing the resist layer, and the concavo-convex pattern is transferred onto the resist layer. It can be particularly suitably used in the present invention's method for producing a magnetic recording medium, explained below.

### <Method for Producing Magnetic Recording Medium>

The present invention's method for producing a magnetic recording medium includes the steps of transferring a concavo-convex pattern formed on the mold structure of the present invention onto an imprint resist layer on a substrate of a magnetic recording medium, by pressing the mold structure against the imprint resist layer; curing the concavo-convex pattern transferred onto the imprint resist layer and separating the mold structure from the imprint resist layer; forming a magnetic pattern portion, which corresponds with the concavo-convex pattern, on a magnetic layer over the surface of the substrate of the magnetic recording medium by etching the magnetic layer, using the imprint resist layer onto which the concavo-convex pattern has been transferred as a mask; and forming a nonmagnetic pattern portion by filling concave portions in the magnetic layer with a nonmagnetic material. Also, the method may include other step(s) according to necessity.

The following explains one example of a method for producing magnetic recording media such as discrete track media or patterned media, with reference to FIG. 3.

### (Transfer Step)

A mold structure incorporating a concavo-convex pattern on its surface is pressed against a resist-layer-coated magnetic recording medium intermediate member in which a resist layer 24 made by applying an imprint resist solution of polymethyl methacrylate (PMMA) or the like onto the magnetic recording medium intermediate member's magnetic layer 50 formed of Fe (or Fe alloy), Co (or Co alloy), etc. is provided on a substrate made of aluminum, glass, silicon, quartz or the like. By doing so, the concavo-convex pattern formed on the mold structure is transferred onto the resist layer 24.

### (Curing Step)

### —Curing by Light Irradiation—

In the case where an imprint resist composition constituting the imprint resist layer contains a photocurable resin, the imprint resist layer is irradiated with an ultraviolet ray, an electron beam or the like via a transparent mold structure 1 for imprinting, and the imprint resist layer is thus cured.

The photocurable resin used herein is a radical polymerization type resin or a cationic polymerization type resin and can be suitably selected from these according to the pattern accuracy and the curing rate that are required.

### —Curing by Heating—

In the case where the imprint resist composition constituting the imprint resist layer contains a thermoplastic resin, when the mold structure 1 for imprinting is pressed against the imprint resist layer, the temperature of the system is kept in the vicinity of the glass transition temperature (Tg) of the resist solution, and after the pattern has been transferred, the imprint resist layer is cured as its temperature becomes lower than the glass transition temperature of the resist solution. Further, if necessary, an ultraviolet ray or the like may be additionally applied to cure the pattern.

In the case where the imprint resist composition contains a thermosetting resin, while the imprint resist composition is kept at room temperature or heated and so shows fluidity, the mold structure 1 for imprinting is pressed against the imprint resist layer to transfer the concavo-convex pattern onto the imprint resist layer, then the imprint resist layer is heated as high as the curing temperature of the resin. By doing so, the imprint resist layer is cured.

### (Magnetic Pattern Portion Forming Step)

Next, dry etching is carried out, using the imprint resist layer onto which the pattern of the concavo-convex portions has been transferred as a mask, and a concavo-convex shape corresponding with the concavo-convex pattern is formed on the magnetic layer.

The dry etching is not particularly limited and can be suitably selected according to the purpose, as long as it makes it possible to provide the concavo-convex shape on the magnetic layer. Examples thereof include ion milling, reactive ion etching (RIE) and sputter etching. Among these, ion milling and reactive ion etching (RIE) are particularly preferable.

The ion milling, also referred to as “ion beam etching”, is a process of injecting an inert gas such as Ar into an ion source to produce ions, and accelerating these ions through a grid to collide with a sample substrate for etching the sample substrate. Examples of the ion source include Kaufman ion sources, high-frequency ion sources, electron impact ion sources, duoplasmatron ion sources, Freeman ion sources, ECR (electron cyclotron resonance) ion sources and closed-drift ion sources.

As a process gas in the ion beam etching, Ar or the like can be used. As an etchant in the RIE, any one of CO+NH₃, chlorine gas, CF gas, CH gas, mixtures of these gases and oxygen gas, nitrogen gas or hydrogen gas, and the like can be used.

### (Nonmagnetic Pattern Portion Forming Step)

Next, concave portions formed in the magnetic layer are filled with a nonmagnetic material to flatten the surface of the magnetic layer, then a protective film and the like are formed according to necessity. By doing so, a magnetic recording medium 100 can be produced.

Examples of the nonmagnetic material include SiO₂, carbon, alumina, polymers such as polymethyl methacrylate (PMMA) and polystyrene (PS), and lubricant oils.

Suitable examples of the material for the protective film include diamond-like carbon (DLC) and sputter carbon. Additionally, a lubricant layer may be provided on the protective film.

The magnetic recording medium produced by the present invention's method for producing a magnetic recording medium is preferably either a discrete magnetic recording medium or a patterned magnetic recording medium.

### EXAMPLES

### Example 1

### Production of Mold Structure

FIGS. 2A and 2B are cross-sectional views showing a method for producing the mold structure in the first embodiment. As shown in FIG. 2A, an electron beam resist was applied onto a Si substrate 10 by spin coating to form a resist layer of 100 nm in thickness. The electron beam resist was exposed with a desired pattern, using a rotary electron beam exposing apparatus, and then subjected to a developing process to yield a resist-coated Si substrate having a concavo-convex pattern.

Subsequently, with the resist pattern serving as a mask, the following reactive ion etching (RIE) was carried out to provide a concavo-convex shape on the Si substrate.
plasma source: ICP (inductively coupled plasma) source
gas: CF gas plus a small amount of hydrogen gas
pressure: 0.5 Pa
electric power supplied: ICP-300 W, bias-50 W

Thereafter, residual resist was washed out with a solvent capable of dissolving it, and then the Si substrate was dried to yield a master plate.

Broadly, the pattern used in Example 1 was functionally divided into a data portion and a servo portion. The data portion was formed of a pattern in which convexities were 120 nm each in width and concavities were 30 nm each in width (TP=150 nm). The servo portion had on its innermost circumference a servo basic bit length of 90 nm and a total sector number of 240 and was formed of a pattern of a preamble (45 bit); a servo mark portion (lobit); a sector code (8 bit) and a cylinder code (32 bit); and a burst portion.

The servo mark portion employed the number “0000101011”, and the sector code and the cylinder code employed binary conversion and gray conversion respectively. The burst portion employed a typical phase burst signal (16 bit).

Next, a photocurable acrylic imprint resist solution (PAK-01 produced by Toyo Gosei Co., Ltd.) was applied onto a quartz substrate by spin coating to form a resist layer of 100 nm in thickness.

Subsequently, the master plate was used as a mold structure and subjected to UV nanoimprinting. In the UV nanoimprinting, the pattern was transferred onto the imprint resist layer under a pressure of 1 MPa for 5 sec, then a UV light of 25 mJ/cm² was applied for 10 sec to cure the pattern.

Selective etching was carried out by the following RIE correspondingly with the concavo-convex resist pattern after the nanoimprinting so as to provide a concavo-convex shape on the quartz substrate.
plasma source: ICP (inductively coupled plasma) source
gas: 1:1 mixture of CF gas and Ar gas, with a small amount of hydrogen gas
pressure: 0.5 Pa
electric power supplied: ICP-300 W, bias-60 W

Thereafter, residual resist was washed out with a solvent capable of dissolving it, and then the quartz substrate was dried to yield a quartz mold. Note that the selective etching was carried out such that concave portions of the mold structure 1 having the concavo-convex shape corresponded with the convex portions 3a in FIG. 1 in cross-sectional shape.

### <Formation of Release Layer>

A release agent layer was formed on the concavo-convex surface of the produced mold structure by a wet process. As the material for the release agent layer, F13-OTCS (tridecafluoro-1,1,2,2-tetrahydro-octyltrichlorosilane) (produced by Gelest, Inc.) was used, and a release layer solution (0.1% by mass) was prepared by dissolving it in a solvent ASAHIKLIN AK225 (produced by Asahi Glass Co., Ltd.). With the use of this release layer solution, a release layer of 5.25 nm in thickness was formed on the quartz mold by a dip method in which the lifting rate was 1 mm/sec.

The mold structure with the release layer was left to stand at 90° C. and at an RH of 80% for 5 hr, and then the release layer material was chemically adsorbed onto the mold structure surface (chemical combining process). The mold structure of Example 1 was thus produced.

### <Production of Magnetic Recording Medium Intermediate Member>

A soft magnetic layer, a first nonmagnetic orientation layer, a second nonmagnetic orientation layer, a magnetic recording layer and a protective layer were deposited in this order over a 2.5-inch glass substrate in the following manner. The soft magnetic layer, the first nonmagnetic orientation layer, the second nonmagnetic orientation layer, the magnetic recording layer and the protective layer were sputtered by sputtering. Additionally, a lubricant layer on the protective layer was formed by a dip method.

Firstly, as the material for the soft magnetic layer, CoZrNb was sputtered to form a layer of 100 nm in thickness. Specifically, the glass substrate was set facing the CoZrNb target, then Ar gas was injected such that its pressure became 0.6 Pa, and the soft magnetic layer was sputtered at 1,500 W (DC).

Secondly, as the first nonmagnetic orientation layer, Pt was sputtered to form a layer of 5 nm in thickness. Specifically, the soft magnetic layer formed over the substrate was set facing the Pt target, then Ar gas was injected such that its pressure became 0.5 Pa, and the first nonmagnetic orientation layer was sputtered at 1,000 W (DC).

Thirdly, as the second nonmagnetic orientation layer, Ru was sputtered to form a layer of 10 nm in thickness. Specifically, the first nonmagnetic orientation layer formed over the substrate was set facing the Ru target, then Ar gas was injected such that its pressure became 0.5 Pa, and the second nonmagnetic orientation layer was sputtered at 1,000 W (DC).

Fourthly, as the magnetic recording layer, CoPtCr—SiO₂ was sputtered to form a layer of 15 nm in thickness. Specifically, the second nonmagnetic orientation layer formed over the substrate was set facing the CoPtCr—SiO₂ target, then Ar gas was injected such that its pressure became 1.5 Pa, and the magnetic recording layer was sputtered at 1,000 W (DC).

Lastly, after the formation of the magnetic recording layer, the protective layer formed over the substrate was set facing a C target, then Ar gas was injected such that its pressure became 0.5 Pa, and the protective layer of 4 nm in thickness was sputtered at 1,000 W (DC). A magnetic recording medium intermediate member was thus produced. The coercive force of the magnetic recording medium intermediate member yielded was 334 kA/m (4.2 kOe).

### <Nanoimprinting and Production of Discrete-Type Perpendicular Magnetic Recording Medium>

A photocurable acrylic imprint resist solution (PAK-01 produced by Toyo Gosei Co., Ltd.) was applied onto the produced magnetic recording medium intermediate member by spin coating to form an imprint resist layer of 100 nm in thickness.

The mold structure was set facing the obtained magnetic recording medium intermediate member with the imprint resist layer. The concavo-convex pattern was transferred onto the resist layer, with the magnetic recording medium intermediate member pressed under a pressure of 1 MPa for 5 sec, then a UV light of 25 mJ/cm² was applied for 10 sec to cure the pattern. Subsequently, the mold structure and the magnetic recording medium intermediate member were separated from each other, and a concavo-convex pattern was thus formed on the imprint resist layer over the magnetic recording medium intermediate member.

Thereafter, as the imprint resist layer 24 onto which the pattern of the concavo-convex portions 3 has been transferred served as a mask, selective etching was carried out by Ar ion sputter etching (ICP plasma source, Ar gas, 0.2 Pa, ICP/bias=750 W/300 W); a concavo-convex shape corresponding with the pattern of the concavo-convex portions 3 on the mold structure 1 for imprinting was formed on the magnetic layer 50; concave portions were filled with a nonmagnetic material 70 (SiO₂ formed by CVD) to flatten the surface of the magnetic layer 50 (by CMP); then a protective layer was formed (a protective layer of DLC was formed by CVD) to yield the magnetic recording medium 100. Thus, a discrete-type perpendicular magnetic recording medium of Example 1 was produced.

### <<Evaluation of Transfer Quality>>

When a concavo-convex pattern (line and space: 50 nm and 50 nm, height: 50 nm) was transferred onto an imprint resist layer on a surface of a substrate using the mold structure of Example 1, a residual film of the imprint resist layer was evaluated in eight locations which were away from the center by 30 nm and apart from one another by 45° . The residual film was observed for thickness using cross-sectional TEM images, and the unevenness of the residual film was evaluated in accordance with the following evaluation standards. The evaluation result is shown in Table 1-2.

### (Evaluation Standards)

A: the amount of unevenness (maximum value—minimum value in terms of thickness) of the residual film was 20 nm or less.
B: the amount of unevenness (maximum value—minimum value in terms of thickness) of the residual film was in the range of 20 nm to 40 nm.
C: the amount of unevenness (maximum value—minimum value in terms of thickness) of the residual film was over 40 nm.

### <<Evaluation of Separability>>

A process of transferring the concavo-convex pattern onto an imprint resist layer on a surface of a substrate with the use of the mold structure of Example 1 was carried out 100 times, and then the extent to which the imprint resist had been damaged or peeled was evaluated in accordance with the following evaluation standards by means of an ultrasonic image method. The evaluation result is shown in Table 1-2.

### (Evaluation Standards)

A: the imprint resist had not been damaged or peeled.
B: the imprint resist had not peeled and had been damaged in five places or fewer.
C: the imprint resist had peeled, or had been damaged in six places or more.

### <<Evaluation of Servo Characteristic>>

Regarding the magnetic recording medium produced above, a position error signal (PES) of a reproduction signal was measured using a magnetic head tester for hard disks (BITFINDER Model-YS 3300 produced by IMES Co., Ltd.) having a GMR head of 0.1 μm in reproduction track width and 0.06 μm in reproduction gap, and the position error signal (PES) was evaluated in accordance with the following evaluation standards. The evaluation result is shown in Table 1-2.

### (Evaluation Standards)

A: a magnetic recording medium capable of servo following, in which the PES was equivalent to less than ±10% of the track width.
B: a magnetic recording medium capable of servo following, in which the PES was equivalent to ±10% or greater and ±20% or less of the track width.
C: a magnetic recording medium incapable of servo following.

### Examples 2 to 12

### Production of Mold Structure

Mold structures of Examples 2 to 12 were produced similarly to the one of Example 1, except that the values of the ten-point average roughness Rz₁ of the apical portions, the ten-point average roughness Rz₂ of the bottom portions (reference surface 2a), the average surface roughness Ra₁ of the apical portions, the average surface roughness Ra₂ of the bottom portions (reference surface 2a) and the average surface roughness Ra₃ of the sidewall portions in Example 1 were changed to the values shown in Table 1-1.

### <Production of Magnetic Recording Medium>

Magnetic recording media of Examples 2 to 12 were produced similarly to the one of Example 1, except that the mold structures produced in Examples 2 to 12 were used instead of the mold structure of Example 1.

### <<Evaluation of Transfer Quality>>

The mold structures of Examples 2 to 12 produced were evaluated for transfer quality as in Example 1. The evaluation results are shown in Table 1-2.

### <<Evaluation of Separability>>

The mold structures of Examples 2 to 12 produced were evaluated for separability as in Example 1. The evaluation results are shown in Table 1-2.

### <<Evaluation of Servo Characteristic>>

The magnetic recording media of Examples 2 to 12 produced were evaluated for servo characteristics as in Example 1. The evaluation results are shown in Table 1-2.

### Examples 13 and 14

### Production of Mold Structure>

FIGS. 4A and 4B are process drawings showing a method for producing a mold structure according to the present Examples.

A master plate 11 having a concavo-convex shape was produced similarly to the one of Example 1 under the conditions of Table 1-1. As shown in FIG. 4B, a conductive film 22 was formed on the surface of the master plate 11 correspondingly with the concavo-convex pattern on the surface thereof by sputtering. Subsequently, the master plate provided with the conductive film 22 was immersed in a Ni electroforming bath of the following composition and electroformed while being rotated at a rotational speed of 50 rpm to 150 rpm, and a Ni plate having a positive concavo-convex pattern of 300 μm in thickness was thus produced. Thereafter, the Ni plate was separated from the master plate, a residual resist film was removed, and the Ni plate was washed. Each one of mold structures of Examples 13 and 14 was thus obtained.

### —Components and Temperature of Ni Electroforming Bath—

| | | |
|---|---|---|
| nickel sulfamate | 600 | g/L |
| boric acid | 40 | g/L |
| surfactant (sodium lauryl sulfate) | 0.15 | g/L |

pH = 4.0
temperature = 55° C.

Note that when a Ni plate 23 was produced with the conductive film 22 having a predetermined thickness, the production was carried out such that concave portions of the Ni plate 23 corresponded with the convex portions 3a in FIGS. 2A and 2B in cross-sectional shape.

### <Production of Magnetic Recording Medium>

An imprint resist solution formed of PMMA resin was applied onto a magnetic recording medium intermediate member produced similarly to the one of Example 1, by spin coating to form an imprint resist layer of 100 nm in thickness.

The mold structure formed of Ni was set facing the obtained magnetic recording medium intermediate member with the imprint resist layer. The concavo-convex pattern was transferred onto the imprint resist layer under a pressure of 3 MPa at a temperature of 150° C. for 30 sec, then the temperature was lowered to 60° C. to cure the pattern. Thereafter, the mold structure and the magnetic recording medium intermediate member were separated from each other, and a concavo-convex pattern was thus formed on the imprint resist layer over the magnetic recording medium intermediate member.

Subsequently, with the concavo-convex pattern serving as a mask, etching was carried out to provide a concavo-convex shape on a magnetic recording layer. Each one of perpendicular magnetic recording media of Examples 13 and 14 was thus produced.

### <<Evaluation of Transfer Quality>>

The mold structures of Examples 13 and 14 produced were evaluated for transfer quality as in Example 1. The evaluation results are shown in Table 1-2.

### <<Evaluation of Separability>>

The mold structures of Examples 13 and 14 produced were evaluated for separability as in Example 1. The evaluation results are shown in Table 1-2.

### <<Evaluation of Servo Characteristic>>

The magnetic recording media of Examples 13 and 14 produced were evaluated for servo characteristics as in Example 1. The evaluation results are shown in Table 1-2.

### Examples 15 and 16

### Production of Mold Structure

FIGS. 5A and 5B are cross-sectional views showing a method for producing a mold structure according to the present Examples.

A master plate 11 having a concavo-convex shape was produced similarly to the one of Example 1 under the master plate processing conditions of Table 1-1. The master plate produced was placed facing a thermoplastic resin sheet formed of PMMA, and the concavo-convex pattern was transferred onto the thermoplastic resin sheet under a pressure of 3 MPa at a temperature of 150° C. for 30 sec, then the temperature was lowered to 60° C. to cure the pattern. Thereafter, the thermoplastic resin sheet was separated from the master plate, and a resin mold structure 1 having a concavo-convex shape was thus obtained.

### <Production of Magnetic Recording Medium>

Magnetic recording media of Examples 15 and 16 were produced similarly to the one of Example 1, except that the mold structures shown in Table 1-1 were used instead of the mold structure of Example 1.

### <<Evaluation of Transfer Quality>>

The mold structures of Examples 15 and 16 produced were evaluated for transfer quality as in Example 1. The evaluation results are shown in Table 1-2.

### <<Evaluation of Separability>>

The mold structures of Examples 15 and 16 produced were evaluated for separability as in Example 1. The evaluation results are shown in Table 1-2.

### <<Evaluation of Servo Characteristic>>

The magnetic recording media of Examples 15 and 16 produced were evaluated for servo characteristics as in Example 1. The evaluation results are shown in Table 1-2.

### Comparative Examples 1 to 3

### Production of Mold Structure

Mold structures of Comparative Examples 1 to 3 were produced similarly to the one of Example 1, except that the values of the ten-point average roughness Rz₁ of the apical portions, the ten-point average roughness Rz₂ of the bottom portions (reference surface 2a), the average surface roughness Ra₁ of the apical portions, the average surface roughness Ra₂ of the bottom portions (reference surface 2a) and the average surface roughness Ra₃ of the sidewall portions in Example 1 were changed to the values shown in Table 1-1.

### <Production of Magnetic Recording Medium>

Magnetic recording media of Comparative Examples 1 to 3 were produced similarly to the one of Example 1, except that the mold structures produced in Comparative Examples 1 to 3 were used instead of the mold structure of Example 1.

### <<Evaluation of Transfer Quality>>

The mold structures of Comparative Examples 1 to 3 produced were evaluated for transfer quality as in Example 1. The evaluation results are shown in Table 1-2.

### <<Evaluation of Separability>>

The mold structures of Comparative Examples 1 to 3 produced were evaluated for separability as in Example 1. The evaluation results are shown in Table 1-2.

### <<Evaluation of Servo Characteristic>>

The magnetic recording media of Comparative Examples 1 to 3 produced were evaluated for servo characteristics as in Example 1. The evaluation results are shown in Table 1-2.

TABLE 1-1

| | Master plate | | Mold processing | | | | | | | |
|---|---|---|---|---|---|---|---|---|---|---|
| | processing condition | | condition | | | | | | | |
| | Pressure | Power | Pressure | Power | Rz₁ | Rz₂ | Ra₁ | Ra₂ | Ra₃ | Raₛ |
| | (Pa) | (ICP/bias) | (Pa) | (ICP/bias) | (nm) | (nm) | (nm) | (nm) | (nm) | (nm) |
| Example 1 | 0.5 | 300/50 | 0.5 | 300/60 | 5 | 10 | 0.5 | 1.5 | 3.5 | 0.5 |
| Example 2 | 0.5 | 300/50 | 0.1 | 150/30 | 0.5 | 0.5 | 0.10 | 0.20 | 1.2 | 0.5 |
| Example 3 | 0.5 | 300/50 | 0.2 | 300/60 | 1 | 10 | 0.10 | 1.2 | 3.2 | 0.5 |
| Example 4 | 0.5 | 300/50 | 0.5 | 300/60 | 5 | 12 | 0.6 | 1.9 | 4 | 0.5 |
| Example 5 | 0.5 | 300/50 | 0.7 | 300/40 | 10 | 10 | 1.20 | 1.20 | 2.8 | 0.5 |
| Example 6 | 0.5 | 300/50 | 0.7 | 300/60 | 10 | 15 | 1.2 | 2.2 | 2.1 | 0.5 |
| Example 7 | 0.5 | 300/50 | 0.7 | 300/80 | 10 | 15 | 1.0 | 2.6 | 3 | 0.5 |
| Example 8 | 0.5 | 300/50 | 1 | 300/80 | 12 | 20 | 1.5 | 2.6 | 1.5 | 0.5 |
| Example 9 | 0.5 | 300/50 | 1.1 | 300/80 | 15 | 20 | 1.5 | 3.2 | 4 | 0.5 |
| Example 10 | 0.5 | 300/50 | 1.2 | 300/80 | 15 | 20 | 1.4 | 3.8 | 4.9 | 0.5 |
| Example 11 | 0.5 | 300/50 | 1.5 | 300/80 | 20 | 20 | 2.6 | 4.8 | 3 | 0.5 |
| Example 12 | 0.5 | 300/50 | 1 | 300/70 | 12 | 14 | 5.5 | 7 | 7.7 | 0.5 |
| Example 13 | 0.5 | 300/60 | none | | 5 | 10 | 0.5 | 1.5 | 3.5 | 0.5 |
| Example 14 | 0.1 | 150/30 | | | 0.5 | 0.5 | 0.10 | 0.20 | 1.2 | 0.5 |
| Example 15 | 0.5 | 300/60 | | | 5 | 10 | 0.5 | 1.5 | 3.5 | 0.5 |
| Example 16 | 0.1 | 150/30 | | | 0.5 | 0.5 | 0.10 | 0.20 | 1.2 | 0.5 |
| Comparative Example 1 | 0.5 | 300/50 | 1 | 300/100 | 10 | 22 | 1.2 | 2.4 | 2.8 | 1.5 |
| Comparative Example 2 | 0.5 | 300/50 | 1.5 | 300/100 | 22 | 25 | 2.5 | 5.5 | 6 | 0.5 |
| Comparative Example 3 | 0.5 | 300/50 | 3 | 600/150 | 50 | 55 | 6.0 | 12 | 15 | 0.5 |

TABLE 1-2

| | | | | Servo |
|---|---|---|---|---|
| | Material of | Transfer | Separ- | charac- |
| | substrate | quality | ability | teristic |
| Example 1 | Quartz | A | A | A |
| Example 2 | Quartz | A | A | A |
| Example 3 | Quartz | A | A | A |
| Example 4 | Quartz | A | A | A |
| Example 5 | Quartz | A | A | A |
| Example 6 | Quartz | A | A | A |
| Example 7 | Quartz | A | A | A |
| Example 8 | Quartz | A | B | A |
| Example 9 | Quartz | A | B | A |
| Example 10 | Quartz | A | B | A |
| Example 11 | Quartz | A | B | A |
| Example 12 | Quartz | B | B | B |
| Example 13 | Ni | A | A | A |
| Example 14 | Ni | A | A | A |
| Example 15 | Resin | A | A | A |
| Example 16 | Resin | A | A | A |
| Comparative Example 1 | Quartz | C | B | C |
| Comparative Example 2 | Quartz | C | C | C |
| Comparative Example 3 | Quartz | C | C | C |

As shown in Tables 1-1 and 1-2, each of Examples 1 to 16 in which both the ten-point average roughness Rz₁ of the apical portions and the ten-point average roughness Rz₂ of the bottom portions are in the range of 0.5 nm to 20 nm made it possible to provide a mold structure which is superior in its adhesion to a substrate whose surface is covered with an imprint resist layer and thus to make uniform the presence of a residual film and the shape of a pattern, which can be problematic in an etching process subsequent to an imprinting process, throughout an entire surface. It should be particularly noted that each of Examples 1 to 7 in which the ten-point average roughness Rz₁ of the apical portions is in the range of 0.5 nm to 10 nm successfully provided a magnetic recording medium which has greater separability than the ones of Examples of 8 to 12 in which the ten-point average roughness Rz₁ of the apical portions is in the range of 10 nm to 20 nm.

Meanwhile, as for Comparative Example 1, the ten-point average roughness Rz₁ satisfied the scope of claim 1, but the ten-point average roughness Rz₂ was beyond this scope. Consequently, regarding the separability of the mold structure, the imprint resist was not damaged or did not peel; however, the transfer quality was insufficient, servo following was hardly possible, and thus Comparative Example 1 exhibited a characteristic fault. It is inferred that this is because the height of the pattern became nonuniform in an etching process subsequent to the transfer of the concavo-convex pattern and thus output from a magnetic layer became unstable. In Comparative Examples 2 and 3, both the ten-point average roughness Rz₁ and the ten-point average roughness Rz₂ were beyond the scope of claim 1. Consequently, Comparative Examples 2 and 3 exhibited poor evaluation results regarding transfer quality and servo characteristics and also could not obtain sufficient separability owing to anchor effect by the mold structures.

By reducing the average surface roughness Ra₁ of the apical portions, the average surface roughness Ra₂ of the bottom portions (reference surface 2a) and the average surface roughness Ra₃ of the sidewall portions to the range of 0.1 nm to 5 nm and so yielding a pattern including smooth surfaces, it was possible to provide a mold structure which causes less anchor effect and is superior in its separability from an imprint resist layer and which allows a high-quality pattern to be transferred and formed on discrete track media and patterned media.

Since the mold structure of the present invention allows a minute pattern formed on the mold structure to enter an imprint resist layer on a substrate efficiently and makes it possible to provide the pattern on the substrate with a high yield, it can be suitably used for producing discrete media and patterned media.

What is claimed is:

1. A mold structure comprising:
convex portions and concave portions formed on its surface,
wherein the mold structure is used for transferring a concavo-convex pattern onto an imprint resist layer formed on a surface of a substrate having a thickness of 0.3 mm to 2.0 mm by pressing the convex portions and the concave portions against the imprint resist layer, and
wherein a ten-point average roughness Rz₁ of apical portions of the convex portions of the mold structure and a ten-point average roughness Rz₂ of bottom portions of the concave portions of the mold structure are in the range of 0.5 nm to 20 nm each.

2. The mold structure according to claim 1, wherein the ten-point average roughness Rz₁ of the apical portions is in the range of 0.5 nm to 10 nm.

3. The mold structure according to claim 1, wherein an average surface roughness Ra₁ of the apical portions, an average surface roughness Ra₂ of the bottom portions and an average surface roughness Ra₃ of sidewall portions are in the range of 0.1 nm to 5 nm each.

4. The mold structure according to claim 1, wherein the average surface roughness Ra₁ of the apical portions and an average surface roughness Raₛ of the surface of the substrate covered with the imprint resist layer satisfy Relationship (1) below.
Ra₁≧Raₛ Relationship (1)

5. The mold structure according to claim 1, having a thickness of 0.5 mm to 10 mm.

6. The mold structure according to claim 1, wherein the mold structure is formed of a material selected from quartz, metal and resin.

7. An imprinting method comprising:
transferring a concavo-convex pattern onto an imprint resist layer on a surface of a substrate by pressing convex portions and concave portions on a surface of a mold structure against the imprint resist layer,
wherein a ten-point average roughness Rz₁ of apical portions of the convex portions and a ten-point average roughness Rz₂ of bottom portions of the concave portions are in the range of 0.5 nm to 20 nm each.

8. A method for producing a magnetic recording medium, comprising:
transferring a concavo-convex pattern formed on a mold structure onto an imprint resist layer formed on a substrate of the magnetic recording medium by pressing the mold structure against the imprint resist layer,
forming a magnetic pattern portion, which corresponds with the concavo-convex pattern, on a magnetic layer on a surface of the substrate of the magnetic recording medium by etching the magnetic layer, using the imprint resist layer onto which the concavo-convex pattern has been transferred as a mask, and
forming a nonmagnetic pattern portion by filling concave portions in the magnetic layer with a nonmagnetic material,
wherein the mold structure comprises convex portions and concave portions formed on its surface,
wherein the mold structure is used for transferring the concavo-convex pattern onto the imprint resist layer formed on the surface of the substrate having a thickness of 0.3 mm to 2.0 mm by pressing the convex portions and the concave portions against the imprint resist layer, and
wherein a ten-point average roughness Rz₁ of apical portions of the convex portions of the mold structure and a ten-point average roughness Rz₂ of bottom portions of the concave portions of the mold structure are in the range of 0.5 nm to 20 nm each.

9. A magnetic recording medium produced by a method for producing a magnetic recording medium, the method comprising:
transferring a concavo-convex pattern formed on a mold structure onto an imprint resist layer formed on a substrate of the magnetic recording medium by pressing the mold structure against the imprint resist layer,
forming a magnetic pattern portion, which corresponds with the concavo-convex pattern, on a magnetic layer on a surface of the substrate of the magnetic recording medium by etching the magnetic layer, using the imprint resist layer onto which the concavo-convex pattern has been transferred as a mask, and
forming a nonmagnetic pattern portion by filling concave portions in the magnetic layer with a nonmagnetic material,
wherein the mold structure comprises convex portions and concave portions formed on its surface,
wherein the mold structure is used for transferring the concavo-convex pattern onto the imprint resist layer formed on the surface of the substrate having a thickness of 0.3 mm to 2.0 mm by pressing the convex portions and the concave portions against the imprint resist layer, and
wherein a ten-point average roughness Rz₁ of apical portions of the convex portions of the mold structure and a ten-point average roughness Rz₂ of bottom portions of the concave portions of the mold structure are in the range of 0.5 nm to 20 nm each.
